(19) United States
(12) Patent Application Publication
(10) Pub. No.: US 2019/0294272 A1
(43) Pub. Date: Sep. 26, 2019

(54) TOUCH CONTROLLER AND TOUCHSCREEN DEVICE

(71) Applicant: Samsung Electronics Co., Ltd., Suwon-si (KR)

(72) Inventors: Yun Rae JO, Yongin-si (KR); Bum Soo KIM, Seoul (KR); Kyeong Gon LEE, Hwaseong-si (KR); Yoon Kyung CHOI, Seoul (KR)

(73) Assignee: Samsung Electronics Co., Ltd., Suwon-si (KR)

(21) Appl. No.: 16/146,039

(22) Filed: Sep. 28, 2018

(30) Foreign Application Priority Data
Mar. 21, 2018 (KR) 10-2018-0032875

(51) Int. Cl. G06F 3/044; G06F 3/041; G09G 3/22

(52) U.S. Cl. CPC G06F 3/044; G06F 3/0416; G09G 2310/08; G09G 2310/0264; G09G 3/22

(57) ABSTRACT

A touch controller includes a driving circuit receiving a clock signal having a first cycle to generate a driving signal, and providing the driving signal to a touch panel; a sensing circuit sensing a sensing signal generated in the touch panel by the driving signal every second cycle, and generating touch data based on the sensing signal; and a control logic controlling the driving circuit and the sensing circuit such that the second cycle is an integer multiple of the first cycle.

### CROSS-REFERENCE TO RELATED APPLICATION

This application claims benefit of priority to Korean Patent Application No. 10-2018-0032875 filed on Mar. 21, 2018 in the Korean Intellectual Property Office, the disclosure of which is incorporated herein by reference in its entirety.

### BACKGROUND

### 1. Field

Example embodiments of the present inventive concepts relate to a touch controller and/or a touchscreen device.

### 2. Description of Related Art

A touchscreen device is a device for sensing a user touch input. The touchscreen device may be applied to various other devices, such as a desktop PC, a television, an air conditioner, a washing machine, or an automobile, as well as a mobile device, such as a smartphone, a tablet PC and a laptop computer. The touchscreen device may include a touch panel and a touch controller, and the touch controller may detect a touch input by sensing a touch signal from the touch panel. In recent years, various techniques have been proposed for improving a performance of touchscreen devices to accurately sense the touch inputs.

### SUMMARY

Example embodiments of the present inventive concepts are related to a touch controller and/or a touchscreen device, capable of accurately detecting a touch input, by significantly reducing a deviation of a noise component included in sensing signals acquired from a touch panel by a touch controller.

According to an example embodiment of the present inventive concepts, a touch controller includes a driving circuit configured to generate a driving signal based on a clock signal, and to provide the driving signal to a touch panel, the clock signal having a first cycle; a sensing circuit configured to sense a sensing signal, and generate touch data based on the sensing signal, the sensing signal being generated by the touch panel based on the driving signal such that the sensing signal has a second cycle; and a controller configured to control the driving circuit and the sensing circuit such that the second cycle is an integer multiple of the first cycle.

According to an example embodiment of the present inventive concepts, a touchscreen device includes a touch panel configured to attach to a front surface of a display device, the display device operating according to a control signal; a driving circuit configured to generate a driving signal based on a clock signal having a first frequency, and to provide the driving signal to the touch panel; a sensing circuit configured to sense a sensing signal, the sensing signal being generated by the touch panel based on the driving signal such that the sensing signal has a second frequency, the second frequency being same as a frequency of the control signal; and a touch controller configured to generate the clock signal such that the first frequency is an integer multiple of the frequency of the control signal.

According to an example embodiment of the present inventive concepts, a touch controller includes a driving circuit operating according to a clock signal having a first frequency, the driving circuit configured to generate a driving voltage to drive touch sensors of a touch panel; a sensing circuit operating according to a sampling frequency, the sensing circuit configured to generate touch data by detecting a change in capacitance from the touch sensors; and a controller configured to generate the clock signal by adjusting the first frequency based on the sampling frequency such that the first frequency is an integer multiple of the sampling frequency.

### BRIEF DESCRIPTION OF DRAWINGS

The above and other aspects, features, and advantages of the present disclosure will be more clearly understood from the following detailed description, taken in conjunction with the accompanying drawings, in which:

FIGS. 1 and 2 are simplified block diagrams of a display system including a touchscreen device according to an example embodiment of the present inventive concepts,

FIGS. 3 and 4 are views illustrating operations of a touchscreen device according to an example embodiment of the present inventive concepts,

FIGS. 5 and 6 are block diagrams illustrating a touchscreen device according to an example embodiment of the present inventive concepts.

FIG. 7 is a waveform diagram illustrating an operation of a touch controller according to an example embodiment of the present inventive concepts,

FIGS. 8 and 9 are circuit diagrams illustrating operations of a driving circuit included in a touch controller according to example embodiments of the present inventive concepts,

FIG. 10 is a block diagram illustrating a touchscreen device according to an example embodiment of the present inventive concepts,

FIG. 11 is a waveform diagram illustrating an operation of a touch controller according to an example embodiment of the present inventive concepts,

FIG. 12 is a block diagram illustrating a touchscreen device according to an example embodiment of the present inventive concepts, and

FIG. 13 is a block diagram illustrating an electronic device including a touchscreen device according to an example embodiment of the present inventive concepts.

### DETAILED DESCRIPTION

Hereinafter, example embodiments of the present inventive concepts will be described with reference to the accompanying drawings.

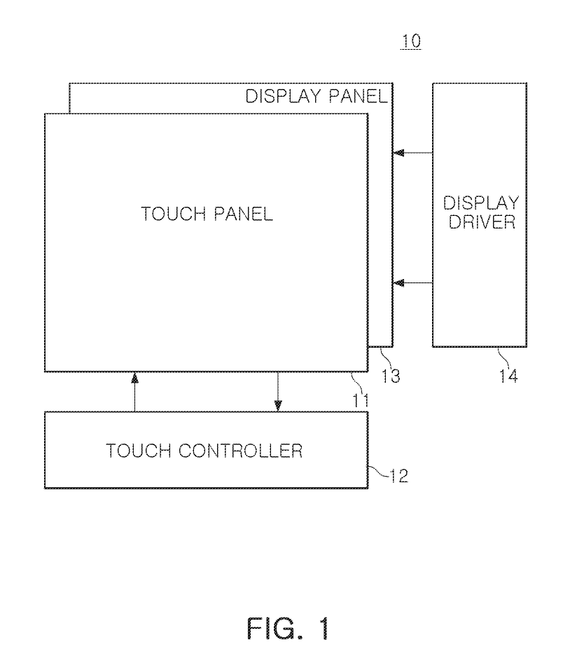

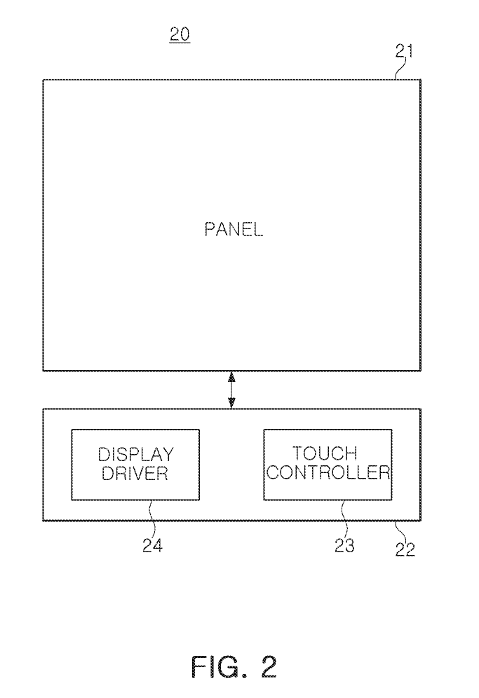

FIGS. 1 and 2 are simplified block diagrams of a display system including a touchscreen device according to an example embodiment of the present inventive concepts.

First, referring to FIG. 1, a display system 10 may include a touch panel 11, a touch controller 12, a display panel 13, and a display driver 14. The display panel 13 and the display driver 14 may provide display devices, such as an organic light emitting display (OLED) and a liquid crystal display (LCD). For example, the display panel 13 may include a plurality of pixels, and the display driver 14 may display a screen on the display panel 13 by inputting a desired (or, alternatively, a predetermined) voltage or current to the plurality of pixels.

The touch panel 11 and the touch controller 12 may provide a touchscreen device. The touch panel 11 may include a plurality of electrodes, and the touch controller 12 may acquire, as a sensing signal, a change in capacitance generated at a plurality of electrodes by a touch input of a user. The touch controller 12 may input a desired (or, alternatively, a predetermined) driving signal to a plurality of electrodes to acquire a sensing signal, and may use the sensing signal to generate touch data corresponding to a touch input of the user.

In an example embodiment shown in FIG. 1, the touch panel 11 may be attached to a front surface of the display panel 13. For example, the touch panel 11 may be provided as a separate module from the display panel 13, and may be attached to the front surface of the display panel 13 to sense the user touch input.

Next, referring to FIG. 2, the display system 20 may include a panel 21 and a controller 22, and the controller 22 may include a touch controller 23 and a display driver 24. In an example embodiment illustrated in FIG. 2, a display panel and a touch panel may be provided as a single panel 21. For example, a single panel 21 may be provided in which a display panel includes electrodes in which a change in capacitance occurs in response to a touch input.

In the example embodiment illustrated in FIG. 2, the touch controller 23 and the display driver 24 may be included in a single controller 22. The touch controller 23 and the display driver 24 may be mounted on a single chip, and may sense a touch input of the user from the panel 21, or display image data on the panel 21.

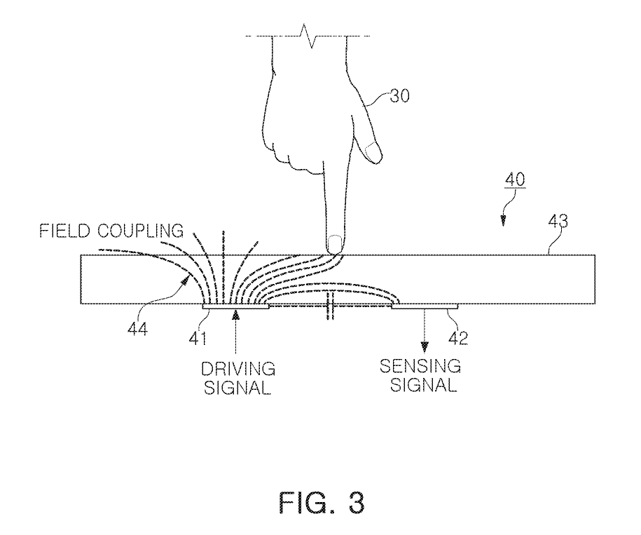

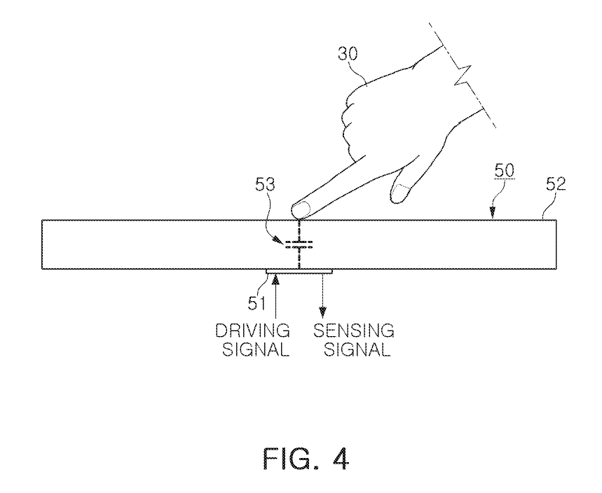

FIGS. 3 and 4 are views illustrating operations of a touchscreen device according to an example embodiment of the present inventive concepts.

Referring to FIG. 3, a touchscreen device 40 according to an example embodiment may sense a touch input by detecting a change in mutual capacitance. The touchscreen device 40 may include a driving electrode 41 and a sensing electrode 42, and the driving electrode 41 and the sensing electrode 42 may be formed on one surface of an insulating layer 43. The insulating layer 43 may be formed of a nonconductive material, and may include a cover glass or the like.

The driving electrode 41 may receive a desired (or, alternatively, a predetermined) driving signal from a touch controller, and a field 44 may be formed between the driving electrode 41 and the sensing electrode 42 by a driving signal. A touch object 30 in contact with the insulating layer 43 may absorb at least a portion of the field 44, and thereby cause a change in mutual capacitance between the driving electrode 41 and the sensing electrode 42. The touch controller may detect the change in mutual capacitance from the sensing electrode 42, to determine the position in which the touch object 30 is in contact, and/or the number of which the touch objects 30 are in contact with the touchscreen device 40. Meanwhile, although the touch object 30 is shown as a portion of the user's body, it may be another conductive material such as a touch pen, or the like.

Referring to FIG. 4, a touchscreen device 50 according to an example embodiment may sense a touch input by detecting a change in self-capacitance 53. The touchscreen device 50 may include a sensing electrode 51 provided on one surface of an insulating layer 52, and a touch controller may input a desired (or, alternatively, a predetermined) driving signal to the sensing electrode 51.

When a touch object 30 is in contact with an insulating layer 52, self-capacitance 53 may be formed between the sensing electrode 51 and the touch object 30. The touch controller may detect a sensing signal corresponding to a change in self-capacitance 53 from the sensing electrode 51, and determine the position of the touch object 30 and/or the number of the touch objects 30 based on the sensing signal.

As described with reference to FIGS. 3 and 4, the touch controller may generate a driving signal, and input the driving signal to the electrodes. The driving signal may be input to the electrodes in the form of a driving voltage or a driving current, and the touch controller may include a circuit for generating a driving signal. In an example embodiment, the touch controller may include a driving circuit for amplifying a desired (or, alternatively, a predetermined) input voltage to generate a driving voltage, and the driving voltage may include a noise component generated during an operation of the driving circuit.

For example, a change in capacitance detected by the touch controller may be defined as a magnitude which capacitance generated by the driving voltage is reduced by the touch input. Therefore, an absolute value of the change in capacitance detected by the touch controller may be influenced by the magnitude of the driving voltage. Further, a magnitude of noise components associated with a touch controller may vary each time the change in capacitance is detected, and thus, conventionally, it may be difficult to accurately detect touch input.

In contrast, in an example embodiment, the driving circuit may be controlled such that the noise component may be reflected in a constant magnitude to the driving voltage, each sampling timing at which the touch controller detects a change in capacitance. Therefore, the touchscreen device may determine the touch input with relatively greater accuracy.

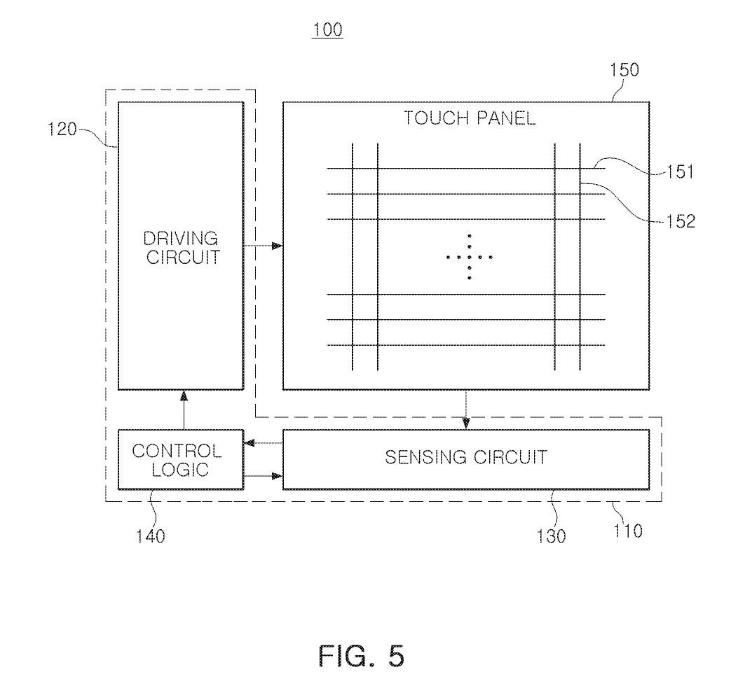

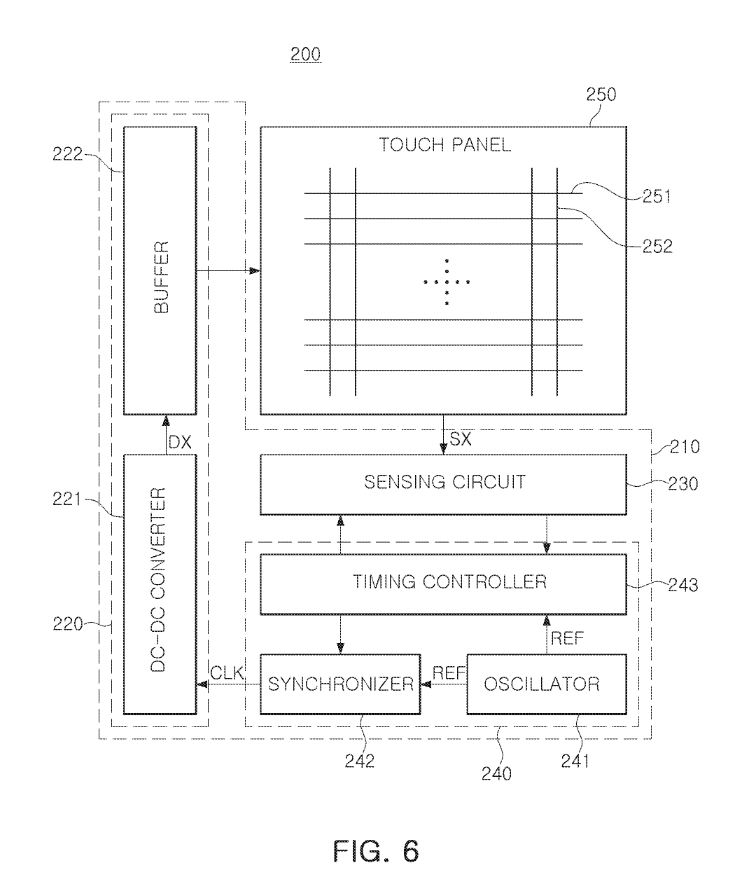

FIGS. 5 and 6 are block diagrams illustrating a touchscreen device according to an example embodiment of the present inventive concepts.

Referring to FIG. 5, a touchscreen device 100 according to an example embodiment may include a touch controller 110 and a touch panel 150. The touch controller 110 may include a driving circuit 120, a sensing circuit 130, and a control logic 140.

The touch panel 150 may include a driving electrode 151 and a sensing electrode 152. In an example embodiment, as illustrated in FIG. 5, it may be assumed that the touchscreen device 100 senses a touch input using a change in mutual capacitance, but example embodiments of the present inventive concepts are not limited thereto. All of the electrodes 151 and 152 included in the touch panel 150 may operate as sensing electrodes, when the touchscreen device 100 detects a touch input using a change in self-capacitance.

The driving circuit 120 may provide a driving signal to the touch panel 150. In an example embodiment, the driving signal may be input to the driving electrode 151 in the form of a voltage or a current. The sensing circuit 130 may sense, as a sensing signal, a mutual capacitance formed between the driving electrode 151 and the sensing electrode 152 by a driving signal, and may generate touch data based on the sensing signal. For example, the touch data may include the position of a touch object contacting the touch panel 150, the number of touch objects, and/or a gesture input generated by the touch object.

The driving circuit 120 may provide the driving signal to the touch panel 150, and may generate the driving signal by operating a clock signal provided by the control logic 140, for example. The clock signal may have a first cycle, and the first cycle may be adjusted by the control logic 140.

On the other hand, the sensing circuit 130 may include a sampling circuit detecting the sensing signal, and the sampling circuit may acquire a sensing signal every second cycle.

The driving circuit 120 may include a DC-DC converter generating a driving signal, and a buffer inputting a driving signal to the touch panel 150. For example, the buffer may include unit buffers corresponding to the driving electrodes 151. The DC-DC converter may be provided as a circuit such as a charge pump, a boost converter, and/or a buck-boost converter. The magnitude of the driving signal output from the DC-DC converter may be determined by an operation of at least one switch elements included in the DC-DC converter. The switch element included in the DC-DC converter may be turned on or off by a clock signal provided to the driving circuit 120 by the control logic 140. Accordingly, the control logic 140 may change the driving signal by adjusting a first cycle of the clock signal, and/or a duty ratio of the clock signal, or the like.

On the other hand, the driving signal may include a noise component, for example, a ripple component, generated by the on/off operation of the switch element included in the DC-DC converter, and the ripple component may be a signal having a first cycle, similar to the clock signal. For example, the magnitude of the ripple component may vary according to the first cycle. Therefore, when a second cycle in which the sensing circuit 130 acquires a sensing signal does not properly match the first cycle, a driving signal having ripple components of different magnitudes may be input to the touch panel 150, each sampling timing at which the sensing circuit 130 acquires the sensing signal. This may lead to a problem that the sensing signal includes noise components of different magnitudes according to the sampling timing.

In an example embodiment, touchscreen device 100 may address the above-mentioned problem by adjusting the first cycle depending on the second cycle. For example, the control logic 140 may determine the first cycle of the clock signal, such that the second cycle when the sensing circuit 130 acquires the sensing signal is an integer multiple of the first cycle of the clock signal to be input to the driving circuit 120. Therefore, a driving signal having a ripple component of the same magnitude may be input to the touch panel 150, each timing when the sensing circuit 130 acquires the sensing signal, and the sensing signal may include a noise component of the same magnitude regardless of the sampling timing. Hereinafter, this will be described in more detail with reference to FIG. 6.

Referring to FIG. 6, a touchscreen device 200 according to an example embodiment may include a touch controller 210 and a touch panel 250.

The touch controller 210 may include a driving circuit 220, a sensing circuit 230 and a control logic 240. The touch panel 250 may include a driving electrode 251 and a sensing electrode 252.

Referring again to and similar to FIG. 5, the electrodes 251 and 252 included in the touch panel 250 may operate as sensing electrodes when sensing a touch input by detecting a change in self-capacitance.

Referring to FIG. 6, the driving circuit 220 may include a DC-DC converter 221 and a buffer 222. The DC-DC converter 221 may include a circuit such as a charge pump, a boost converter, and a buck-boost converter, and may amplify a desired (or, alternatively a predetermined) input voltage to generate a driving signal DX. For example, the DC-DC converter 221 may include at least one switch element that is turned on or off by a clock signal CLK provided by the control logic 240. Further, characteristics of the driving signal DX may be determined by the clock signal CLK controlling the switch element. For example, the magnitude of the driving signal DX may be determined by the duty ratio or the frequency of the clock signal CLK.

The control logic 240 may include an oscillator 241, a synchronizer 242, a timing controller 243, and the like.

The oscillator 241 may generate a reference signal REF, and provide it to the synchronizer 242 and the timing controller 243. The synchronizer 242 may adjust the cycle of the reference signal REF to generate the clock signal CLK, and may input the clock signal CLK to the DC-DC converter 220. The timing controller 243 may control an operation of the sensing circuit 230, and may determine the sampling cycle in which the sensing circuit 230 acquires a sensing signal SX in a second cycle, and may provide the same to the synchronizer 242.

In an example embodiment, the synchronizer 242 may generate the clock signal CLK by adjusting a cycle of the reference signal REF with reference to the sampling cycle provided from the timing controller 243. For example, the synchronizer 242 may generate the clock signal CLK having the first cycle by adjusting the cycle of the reference signal REF, the second cycle may be an integer multiple of the first cycle. For example, when a frequency of the clock signal CLK is defined as a first frequency, and a sampling frequency at which the sensing circuit 230 acquires the sensing signal SX is defined as a second frequency, the first frequency may be an integer multiple of the second frequency.

The DC-DC converter 221 may be operated by the clock signal CLK to generate the driving signal DX, such that the driving signal DX may include a noise component having the first cycle. In an example embodiment, the second cycle in which the sensing circuit 230 acquires the sensing signal SX may be synchronized with an integer multiple of the first cycle of the noise component included in the driving signal DX. Therefore, when the sensing signal SX is obtained irrespective of the sampling timing, the driving signal DX input to the touch panel 250 may include a noise component of the same magnitude. As a result, the sensing circuit 230 may acquire the sensing signal SX having a certain noise component to sense the touch input, thereby improving the performance of the touchscreen device 200.

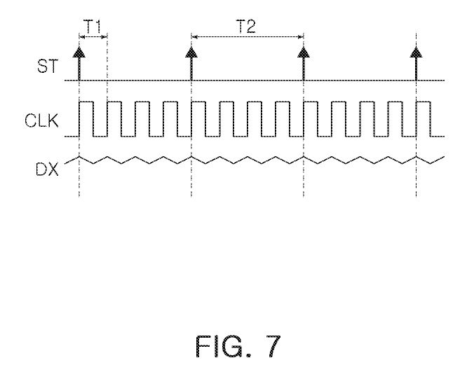

FIG. 7 is a waveform diagram illustrating an operation of a touch controller according to an example embodiment of the present inventive concepts.

Referring to FIGS. 6 and 7, FIG. 7 may be a waveform diagram for illustrating a sampling signal ST for determining the sampling timing at which a sensing circuit 230 acquires a sensing signal SX, a clock signal CLK to be input to a DC-DC converter 221 by a control logic 240, and a driving signal DX to be output by a driving circuit 220.

The driving signal DX may include a noise component that increases or decreases in a desired (or, alternatively, a predetermined) cycle. The noise component may be generated by on/off operation of a switch element included in the DC-DC converter 221. As described above, the switch element included in the DC-DC converter 221 may be turned on or off by the clock signal CLK. Therefore, the noise component included in the driving signal DX may have a first cycle such as the clock signal CLK.

The control logic 240 may generate the clock signal CLK with reference to the sampling signal ST. In an example embodiment, the control logic 240 may generate the clock signal CLK such that the second cycle T2 of the sampling signal ST is an integer multiple of the first cycle T1 of the clock signal CLK. As described in the frequency domain, the control logic 240 may generate the clock signal CLK such that the frequency of the clock signal CLK is an integer multiple of the frequency of the sampling signal ST.

Therefore, as illustrated in FIG. 7, the driving signal DX having the noise component of the same magnitude may be input to the touch panel, each sampling timing at which the sensing circuit 230 acquires the sensing signal SX. For example, since the sensing signal SX obtained by the sensing circuit 230 is always generated by the driving signal DX of the same magnitude, the problem that the driving signal DX includes noise of a random size may be addressed, thereby improving the performance of the touchscreen device 200.

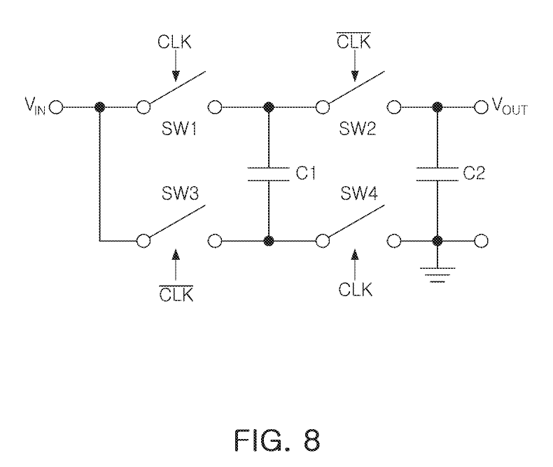

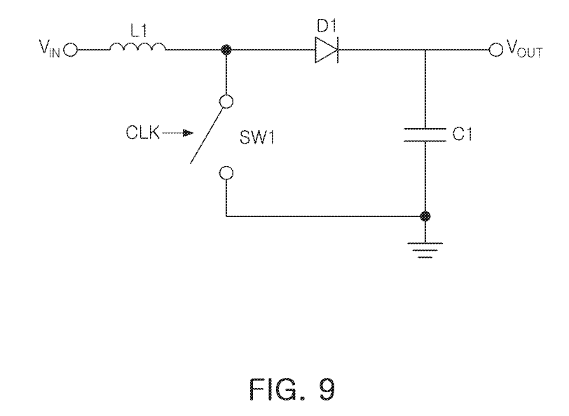

FIGS. 8 and 9 are circuit diagrams illustrating operations of a driving circuit included in a touch controller according to example embodiments of the present inventive concepts.

A touch controller according to an example embodiment may include a driving circuit for inputting a driving signal to a touch panel. The driving circuit may include a DC-DC converter for generating a driving signal, and a buffer for inputting a driving signal to a touch panel. A circuit according to the example embodiments shown in FIGS. 8 and 9 may be an example of the DC-DC converter that may be included in the driving circuit.

Referring to FIG. 8, a driving circuit according to an example embodiment may include a charge pump as a DC-DC converter. The charge pump may include a plurality of switches SW1 to SW4, which are turned on or off by the clock signal CLK, and a plurality of capacitors C1 and C2. The first and fourth switches SW1 and SW4 among the plurality of switches SW1 to SW4 may be turned on or off by the clock signal CLK, and the second and third switches SW2 and SW3 may be turned on or off by a complementary signal of the clock signal CLK. In an example embodiment, the first and fourth switches SW1 and SW4 may be turned on when the clock signal CLK has a high logic value, and may be turned off when the clock signal CLK has a low logic value. Meanwhile, the second and third switches SW2 and SW3 may be turned on when the clock signal CLK has a low logic value, and may be turned off when the clock signal CLK has a high logic value. The clock signal CLK may be provided by the control logic included in the touch controller.

When the first and fourth switches SW1 and SW4 are turned on, the first capacitor C1 may be charged by an input voltage V_{IN}. When the first and fourth switches SW1 and SW4 are turned off, and the second and third switches SW2 and SW3 are turned on, the second capacitor C2 may be charged by a voltage charged in the first capacitor C1 together with the input voltage V_{IN}. Thus, an output voltage V_{OUT} may be greater than the input voltage V_{IN}.

In an example embodiment shown in FIG. 8, the output voltage V_{OUT} of the charge pump may be input as a driving signal to the touch panel, and the output voltage V_{OUT} may include noise components generated by the on/off operations of the first to fourth switches SW1 to SW4. Therefore, the noise component included in the output voltage V_{OUT} may be a signal having the same frequency as the frequency of the clock signal CLK controlling the first to fourth switches SW1 to SW4.

Referring to FIG. 9, a driving circuit according to an example embodiment may include a boost converter as a DC-DC converter. The boost converter may include an inductor L1, a diode D1, a capacitor C1 and a switch SW1, and the switch SW1 may be turned on or off by a clock signal CLK. The clock signal CLK may be provided by a control logic included in a touch controller.

When the clock signal CLK has a high logic value, the switch SW1 may be turned on, and the inductor L1 may be charged with energy by an input voltage V_{IN}. When the clock signal CLK is converted to the low logic value and the switch SW1 is turned off, an output voltage V_{OUT} may be generated by the input voltage V_{IN} and the energy charged in the inductor L1. Thus, the output voltage V_{OUT} may be greater than the input voltage V_{IN}.

In an example embodiment shown in FIG. 9, the output voltage V_{OUT} of the boost converter may be input as a driving signal to the touch panel, and the output voltage V_{OUT} of the boost converter may include noise components generated by the on/off operation of the switch SW. Therefore, the noise component included in the output voltage V_{OUT} may be a signal having the same frequency as the frequency of the clock signal CLK controlling the switch SW.

The sensing signal obtained by the sensing circuit of the touch controller from the touch panel may correspond to a change in capacitance generated at the sensing electrode of the touch panel by the driving signal. Therefore, when the magnitude of the driving signal input to the touch panel is different each sampling timing for acquiring the sensing signal, the change in capacitance may not be accurately detected, which may lead to deterioration of the performance of the touchscreen device.

In an example embodiment, the above problem may be addressed by exploiting the fact that the noise component included in the driving signal is a signal having the same frequency as the clock signal CLK. For example, in one or more example embodiments, the control logic 240 of the touch controller may generate a clock signal CLK and may input it to the DC-DC converter, such that the frequency of the clock signal CLK is an integer multiple of the sampling frequency at which the sense circuit acquires the sense signal. Therefore, the output voltage V_{OUT} having the noise component of the same magnitude may be input to the touch panel as the driving signal, each sampling timing at which the sensing circuit detects a change in capacitance. As a result, the change in capacitance detected by the sensing circuit irrespective of the sampling timing may be generated by the driving signal of the same magnitude, and the deterioration of the performance of the touchscreen device due to the random noise component may be reduced (or, alternatively, prevented).

Meanwhile, the touch controller according to an example embodiment may improve the performance of the touchscreen device by significantly reducing the influence of noise components introduced from the outside of the touchscreen device, in addition to the noise components generated in the touch controller. For example, the control logic of the touch controller may receive a control signal having a desired (or, alternatively, a predetermined) frequency from an external noise source, and may generate a clock signal CLK to be an integer multiple of the frequency of the control signal, to provide the same to the DC-DC converter of the driving circuit. Therefore, the change in capacitance detected by the sensing signal irrespective of the sampling timing may be generated by the driving signal having the noise component of the same magnitude, and the deterioration of the performance of the touchscreen device due to the random noise component may be significantly reduced.

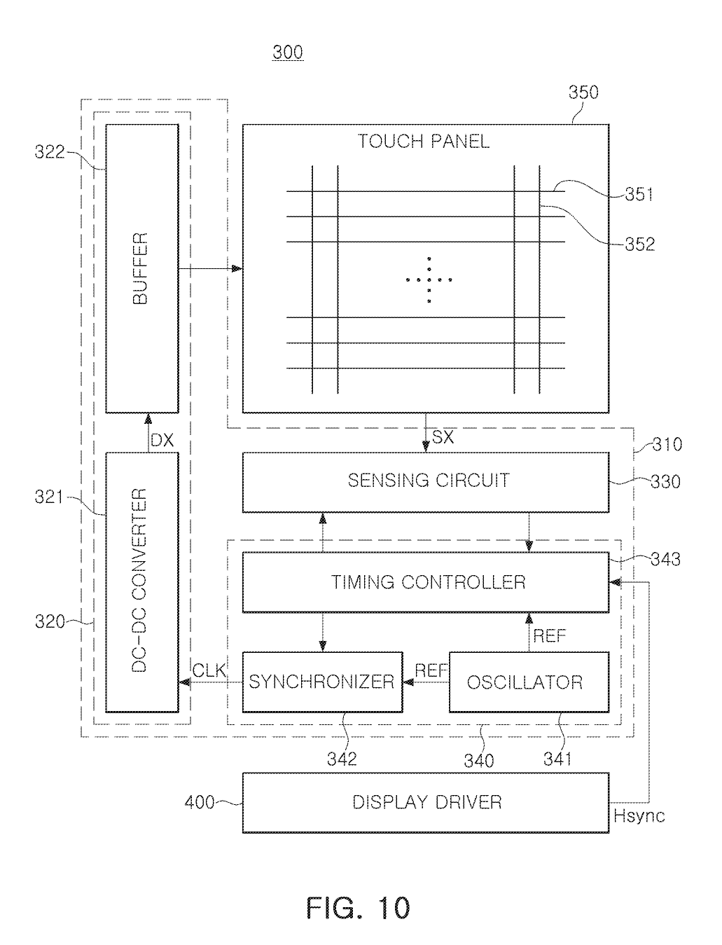

FIG. 10 is a block diagram illustrating a touchscreen device according to an example embodiment of the present inventive concepts.

Referring to FIG. 10, the touchscreen device 300 according to an example embodiment may include a touch controller 310 and a touch panel 350.

The touch controller 310 may include a driving circuit 320, a sensing circuit 330, and control logic 340. The touch panel 350 may include a driving electrode 351 and a sensing electrode 352. Referring again to and similar to FIGS. 5 and 6, the electrodes 351 and 352 included in the touch panel 350 may function as sensing electrodes when a touch input is sensed by detecting a change in capacitance of the touch panel 350.

The driving circuit 320 may include a DC-DC converter 321 and a buffer 322. The DC-DC converter 321 may include a circuit such as a charge pump, a boost converter, and a buck-boost converter, and may amplify an input voltage to generate a driving signal DX.

The control logic 340 may include an oscillator 341, a synchronizer 342, a timing controller 343, and the like. The oscillator 341 may generate a reference signal REF, and may provide it to the synchronizer 342 and the timing controller 343. The synchronizer 342 may adjust a cycle of the reference signal REF to generate a clock signal CLK, and may input the clock signal CLK to the DC-DC converter 320. The timing controller 343 may control the operation of the sensing circuit 330, and may receive the sampling cycle in which the sensing circuit 330 acquires a sensing signal SX in a second cycle, and provide the same to the synchronizer 342.

The touchscreen device 300 may be attached to a front surface of a conventional display device. Therefore, the display device may act as the largest noise source for the touchscreen device 300. The touch controller 310 may receive a control signal from the display driver 400, and may synchronize the clock signal CLK with the control signal such that the interference from the display device is reflected constantly to the sensing signal SX.

The timing controller 343 may receive a horizontal synchronizing signal Hsync from the display driver 400. The horizontal synchronizing signal Hsync may be a signal that the display driver 400 scans each of a plurality of gate lines included in the display panel. When the clock signal CLK has a first frequency and the horizontal synchronizing signal Hsync has a second frequency, the control logic 340 may generate the clock signal CLK such that the first frequency is an integer multiple of the second frequency. For example, the timing controller 343 may receive the horizontal synchronizing signal Hsync, and may transmit the second frequency to the synchronizer 342. The synchronizer 342 may determine the first frequency of the clock signal CLK with reference to the second frequency.

The driving signal DX generated by the DC-DC converter 321 may further include an external noise component generated by the display driver 400, in addition to an internal noise component generated in an operation of a switch controlled by the clock signal CLK. The internal noise component may be a signal that is synchronized with the clock signal CLK, and the external noise component may be a signal that determines the operation of the display driver 400, for example, a signal that is synchronized to the horizontal synchronizing signal Hsync.

In an example embodiment, the first frequency of the clock signal CLK may be set to have an integer multiple of the second frequency of the horizontal synchronizing signal Hsync. Meanwhile, the above problem may be addressed by synchronizing the sampling frequency, which the sensing circuit 330 acquires the sensing signal SX, with the second frequency. For example, the timing controller 343 may set the sampling frequency of the sensing circuit 330 to have the same value as the second frequency. Therefore, the driving signal DX including the external noise component of the driving signal DX may be input to the touch panel 350, each sampling timing at which the sensing circuit 330 acquires the sensing signal SX. As a result, the sensing circuit 230 may sense the touch input as the sensing signal SX by sensing the change in capacitance generated by the driving signal DX having a certain internal/external noise component. Therefore, the performance of the touchscreen device 200 may be improved, while reducing influences by the random noise component.

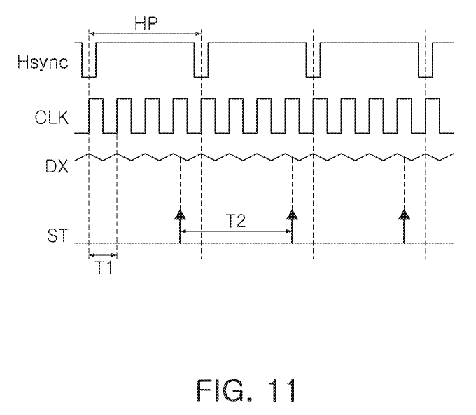

FIG. 11 is a waveform diagram illustrating an operation of a touch controller according to an example embodiment of the present inventive concepts.

Referring to FIGS. 10 and 11, FIG. 11 may be a waveform diagram for illustrating a sampling signal ST for determining the sampling timing at which a sensing circuit 330 acquires the sensing signal SX, a clock signal CLK for inputting to a DC-DC converter 321 by a control logic 340, a driving signal DX for outputting by a driving circuit 320, and a horizontal synchronizing signal Hsync generated by a display driver 400.

The driving signal DX may include a noise component. The noise component may include an internal noise component generated by on/off operation of a switch element included in the DC-DC converter 321, and an external noise component generated by an operation of the display driver 400.

The control logic 340 may generate the clock signal CLK with reference to the horizontal synchronizing signal Hsync. For example, the control logic 340 may generate the clock signal CLK such that a horizontal cycle HP of the horizontal synchronizing signal Hsync is an integer multiple of a first cycle T1 of the clock signal CLK. As described in the frequency domain, the control logic 340 may generate the clock signal CLK such that the frequency of the clock signal CLK is an integer multiple of the frequency of the horizontal synchronizing signal Hsync.

Also, the control logic 340 may adjust the sampling signal ST with reference to the horizontal synchronizing signal Hsync. For example, the control logic 340 may determine the second cycle T2 of the sampling signal ST to have the same value as the horizontal cycle HP of the horizontal synchronizing signal Hsync. For example, the frequency of the sampling signal ST may be equal to the frequency of the horizontal synchronizing signal Hsync.

Therefore, as illustrated in FIG. 11, the driving signal DX having an internal noise component and an external noise component of the same magnitude may be input to the touch panel, each sampling timing at which the sensing circuit 330 acquires the sensing signal SX. A capacitance may be generated by the driving signal DX of the same magnitude each sampling timing, and the sensing circuit 330 may detect the change in capacitance generated by the driving signal DX of the same magnitude as the sensing signal SX. Therefore, it is possible to address the problem that the accuracy of the sensing signal SX is reduced by generating the capacitance by the driving signal DX having the noise component of a random size, thereby improving the performance of the touchscreen device 300.

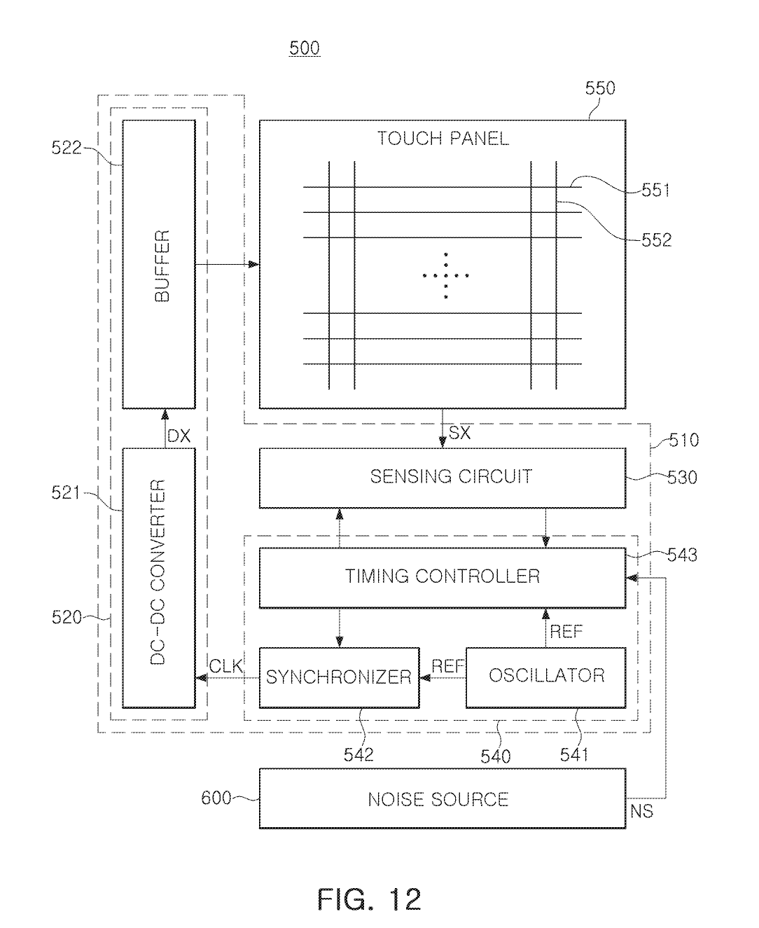

FIG. 12 is a block diagram illustrating a touchscreen device according to an example embodiment of the present inventive concepts.

Referring to FIG. 12, a touchscreen device 500 according to an example embodiment may include a touch controller 510, and a touch panel 550. The touch controller 510 may include a driving circuit 520, a sensing circuit 530, and a control logic 540. The touch panel 550 may include a driving electrode 551, and a sensing electrode 552. The configuration and operation of the driving circuit 520, the sensing circuit 530 and the control logic 540 may be similar to those of the embodiment described with reference to FIG. 10.

A timing controller 543 of the control logic 540 may receive a noise signal NS from a noise source 600 externally. The noise signal NS may be a control signal required for operation of the noise source 600 as a signal that may interfere with the operation of the touchscreen device 500 by an external noise component. For example, when the noise source 600 is a display device, the noise signal NS may be a vertical synchronizing signal or a horizontal synchronizing signal, and when the noise source 600 is an image sensor, the noise signal NS may be a control signal required to output image data by the image sensor.

The timing controller 543 may transmit a cycle and/or a frequency of the noise signal NS to the synchronizer 542. The synchronizer 542 may generate a clock signal CLK with reference to the cycle and/or frequency of the noise signal NS. As described above, the clock signal CLK may be a signal for controlling the DC-DC converter that generates a driving signal DX. For example, the synchronizer 542 may generate the clock signal CLK such that the frequency of the clock signal CLK is N times the frequency of the noise signal NS, or 1/N times the frequency of the noise signal NS.

The timing controller 543 may also determine a sampling frequency at which the sensing circuit 530 acquires a sensing signal SX based on the cycle and/or frequency of the noise signal NS. In one embodiment, the timing controller 543 may control the sensing circuit 530 such that the sampling frequency is N times the frequency of the noise signal NS, or 1/N times the frequency of the noise signal NS. Therefore, a magnitude of the noise component included in driving signal DX by an operation of the noise source 600 and the DC-DC converter 521 may be kept constant each sampling timing at which the sensing circuit 530 acquires the sensing signal SX. For example, since the sensing signal SX acquired by the sensing circuit 530 at the sampling timing is generated from the driving signal DX of the same magnitude, a deviation of the sensing signal SX according to the noise component may be significantly reduced, and a performance of the touchscreen device 500 may be improved.

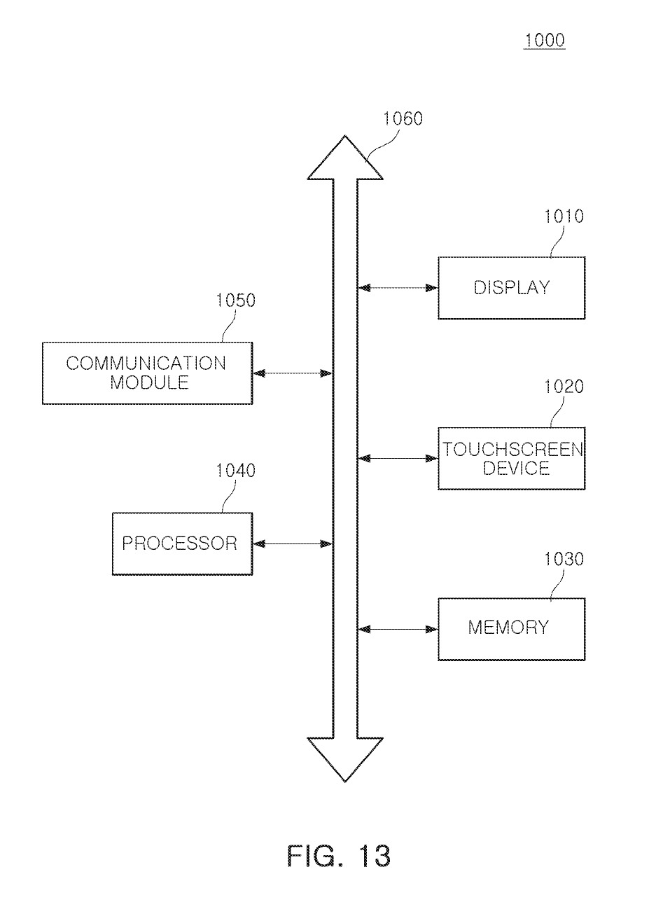

FIG. 13 is a block diagram illustrating an electronic device including a touchscreen device according to an example embodiment of the present inventive concepts.

Referring to FIG. 13, an electronic device 1000 according to an example embodiment may include a display 1010, a touchscreen device 1020, a memory 1030, a processor 1040, and a communication module 1050. The electronic device 1000 may include a television, a desktop computer, etc. in addition to a mobile device such as a smartphone, a tablet PC, a laptop computer, and the like. Components such as the display 1010, the touchscreen device 1020, the memory 1030, the processor 1040, and the communication module 1050 may communicate with each other via a bus 1060.

The touchscreen device 1020 may include a touch controller and a touch panel, which may include a driving circuit, a sensing circuit, and a control logic. The control logic may set an operating frequency of the DC-DC converter included in the driving circuit to an integer multiple of the sampling frequency by referring to a sampling frequency at which the sensing circuit detects a change in capacitance from the touch panel. Therefore, the sensing circuit may detect a change in capacitance generated by the same driving signal each sampling timing according to the sampling frequency, and a deviation of the sensing signal according to the noise component may be significantly reduced.

According to an example embodiment, the cycle of the clock signal for generating the driving signal input to the touch panel may be adjusted with reference to the cycle for acquiring the sensing signal from the touch panel. The clock signal may be generated such that the cycle for acquiring the sensing signal from the touch panel is an integer multiple of the cycle of the clock signal, thereby significantly reducing the deviation between the noise components included in the sensing signal to improve the performance of the touch controller and the touchscreen device.

According to one or more example embodiments, the units and/or devices described above, such as the components of the touchscreen devices (e.g., 100, 200, 300 and 500) including the touch controller (e.g., 110, 210, 310 and 510) as well as the sub-components thereof including the various driving circuits, sensing circuits and control logic (e.g., 140, 240, 340, and 540) may be implemented using hardware, a combination of hardware and software, or a non-transitory storage medium storing software that is executable to perform the functions of the same.

Hardware may be implemented using processing circuity such as, but not limited to, one or more processors, one or more Central Processing Units (CPUs), one or more controllers, one or more arithmetic logic units (ALUs), one or snore digital signal processors (DSPs), one or more microcomputers, one or more field programmable gate arrays (FPGAs), one or more System-on-Chips (SoCs), one or more programmable logic units (PLUS), one or more microprocessors, one or more Application Specific Integrated Circuits (ASICs), or any other device or devices capable of responding to and executing instructions in a defined manner.

Software may include a computer program, program code, instructions, or some combination thereof, for independently or collectively instructing or configuring a hardware device to operate as desired. The computer program and/or program code may include program or computer-readable instructions, software components, software modules, data files, data structures, etc., capable of being implemented by one or more hardware devices, such as one or more of the hardware devices mentioned above. Examples of program code include both machine code produced by a compiler and higher level program code that is executed using an interpreter.

For example, when a hardware device is a computer processing device (e.g., one or more processors, CPUs, controllers, ALUs, DSPs, microcomputers, microprocessors, etc.), the computer processing device may be configured to carry out program code by performing arithmetical, logical, and input/output operations, according to the program code. Once the program code is loaded into a computer processing device, the computer processing device may be programmed to perform the program code, thereby transforming the computer processing device into a special purpose computer processing device. In a more specific example, when the program code is loaded into a processor, the processor becomes programmed to perform the program code and operations corresponding thereto, thereby transforming the processor into a special purpose processor. In another example, the hardware device may be an integrated circuit customized into special purpose processing circuitry (e.g., an ASIC).

A hardware device, such as a computer processing device, may run an operating system (OS) and one or more software applications that run on the OS. The computer processing device also may access, store, manipulate, process, and create data in response to execution of the software. For simplicity, one or more example embodiments may be exemplified as one computer processing device; however, one skilled in the art will appreciate that a hardware device may include multiple processing elements and multiple types of processing elements. For example, a hardware device may include multiple processors or a processor and a controller. In addition, other processing configurations are possible, such as parallel processors.

Software and/or data may be embodied permanently or temporarily in any type of storage media including, but not limited to, any machine, component, physical or virtual equipment, or computer storage medium or device, capable of providing instructions or data to, or being interpreted by, a hardware device. The software also may be distributed over network coupled computer systems so that the software is stored and executed in a distributed fashion. In particular, for example, software and data stay be stored by one or more computer readable recording mediums, including tangible or non-transitory computer-readable storage media as discussed herein.

Storage media may also include one or more storage devices at units and/or devices according to one or more example embodiments. The one or more storage devices may be tangible or non-transitory computer-readable storage media, such as random access memory (RAM), read only memory (ROM), a permanent mass storage device (such as a disk drive), and/or any other like data storage mechanism capable of storing and recording data. The one or more storage devices may be configured to store computer programs, program code, instructions, or some combination thereof, for one or more operating systems and/or for implementing the example embodiments described herein.

The computer programs, program code, instructions, or some combination thereof, may also be loaded from a separate computer readable storage medium into the one or more storage devices and/or one or more computer processing devices using a drive mechanism. Such separate computer readable storage medium may include a Universal Serial Bus (USB) flash drive, a memory stick, a Blu-ray/DVD/CD-ROM drive, a memory card, and/or other like computer readable storage media. The computer programs, program code, instructions, or some combination thereof, may be loaded into the one or more storage devices and/or the one or more computer processing devices from a remote data storage device via a network interface, rather than via a computer readable storage medium. Additionally, the computer programs, program code, instructions, or some combination thereof, may be loaded into the one or more storage devices and/or the one or more processors from a remote computing system that is configured to transfer and/or distribute the computer programs, program code, instructions, or some combination thereof, over a network. The remote computing system may transfer and/or distribute the computer programs, program code, instructions, or some combination thereof, via a wired interface, an air interface, and/or any other like medium.

The one or more hardware devices, the storage media, the computer programs, program code, instructions, or some combination thereof, may be specially designed and constructed for the purposes of the example embodiments, or they may be known devices that are altered and/or modified for the purposes of example embodiments.

The various and advantageous advantages and effects of example embodiments of the present inventive concepts are not limited to the above description, and can be more easily understood in the course of describing a specific embodiment of the present inventive concepts.

While example embodiments have been shown and described above, it will be apparent to those skilled in the art that modifications and variations could be made without departing from the scope of example embodiments the present inventive concepts as defined by the appended claims.

What is claimed is:

1. A touch controller comprising:
a driving circuit configured to generate a driving signal based on a clock signal, and to provide the driving signal to a touch panel, the clock signal having a first cycle;
a sensing circuit configured to sense a sensing signal, and generate touch data based on the sensing signal, the sensing signal being generated by the touch panel based on the driving signal such that the sensing signal has a second cycle; and
a controller configured to control the driving circuit and the sensing circuit such that the second cycle is an integer multiple of the first cycle.

2. The touch controller according to claim 1, wherein the controller is configured to adjust the first cycle associated with the clock signal such that the second cycle associated with the sensing signal is an integer multiple of the first cycle.

3. The touch controller according to claim 1, wherein the controller is configured to,
generate a reference signal,
generate the clock signal based on the reference signal by adjusting a cycle of the reference signal such that the clock signal has the first cycle, and
control the driving circuit based on the clock signal.

4. The touch controller according to claim 3, wherein the controller includes a synchronizer configured to only adjust the cycle of the reference signal to generate the clock signal.

5. The touch controller according to claim 3, wherein the controller is configured to,
receive a horizontal synchronizing signal from a display controller of a display device attached to the touch panel, and
generate the clock signal such that a cycle associated with the horizontal synchronizing signal is an integer multiple of the first cycle associated with the clock signal.

6. The touch controller according to claim 5, wherein the second cycle associated with the sensing signal is equal to the cycle associated with the horizontal synchronizing signal.

7. The touch controller according to claim 1, wherein the driving circuit includes,
a DC-to-DC converter configured to amplify a DC voltage to generate the driving signal based on the clock signal, and
a buffer configured to input the driving signal to the touch panel.

8. The touch controller according to claim 7, wherein the DC-to-DC converter includes at least one switch configured to switch based on the clock signal.

9. The touch controller according to claim 1, wherein
the driving circuit is configured to generate the driving signal based on the clock signal such that the driving signal includes a noise component influenced by the clock signal, and
the touch panel is configured to generate the sensing signal such that a magnitude of the noise component reflected in the sensing signal is same as a magnitude of the noise component in the driving signal.

10. The touch controller according to claim 1, wherein the sensing circuit includes a sampling circuit configured to detect a change in capacitance generated in the touch panel by sampling, based on a sampling cycle, the sensing signal such that the sampling cycle of the sampling circuit is same as the second cycle associated with the sensing signal.

11. A touchscreen device comprising:
a touch panel configured to attach to a front surface of a display device, the display device operating according to a control signal;
a driving circuit configured to generate a driving signal based on a clock signal having a first frequency, and to provide the driving signal to the touch panel;
a sensing circuit configured to sense a sensing signal, the sensing signal being generated by the touch panel based on the driving signal such that the sensing signal has a second frequency, the second frequency being same as a frequency of the control signal; and
a touch controller configured to generate the clock signal such that the first frequency is an integer multiple of the frequency of the control signal.

12. The touchscreen device according to claim 11, wherein the driving circuit includes
a DC-DC converter configured to amplify a DC voltage to generate the driving signal based on the clock signal, and
a buffer configured to input the driving signal to the touch panel.

13. The touchscreen device according to claim 12, wherein the DC-DC converter is configured to generate the driving signal based on the clock signal such that the driving signal includes a noise component having the first frequency.

14. The touchscreen device according to claim 13, wherein the driving circuit includes at least one switch configured to switch based on the clock signal to generate the driving signal such that switching of the switch results in the driving signal including the noise component.

15. The touchscreen device according to claim 13, wherein
the sensing circuit includes a sampling circuit configured to detect a change in capacitance generated in the touch panel by sampling, based on a sampling cycle, the sensing signal, and
the touch controller is configured to generate the clock signal such that, for each cycle of the sampling cycle of the sampling circuit, a noise component included in the driving signal has a same magnitude.

16. The touchscreen device according to claim 11, wherein the control signal is a horizontal synchronizing signal of the display device.

17. The touchscreen device according to claim 16, wherein the sensing circuit is configured to detect the sensing signal once during each cycle of the horizontal synchronizing signal.

18. A touch controller comprising:
a driving circuit operating according to a clock signal having a first frequency, the driving circuit configured to generate a driving voltage to drive touch sensors of a touch panel;
a sensing circuit operating according to a sampling frequency, the sensing circuit configured to generate touch data by detecting a change in capacitance from the touch sensors; and
a controller configured to generate the clock signal by adjusting the first frequency based on the sampling frequency such that the first frequency is an integer multiple of the sampling frequency.

19. The touch controller according to claim 18, wherein the controller is configured to set the first frequency of the clock signal by adjusting a frequency of a reference signal based on the sampling frequency.

20. The touch controller according to claim 18, wherein the driving circuit includes a DC-DC converter, the DC-DC converter including at least one switch configured to switch based on the clock signal.
